(19) United States
(12) Patent Application Publication
(10) Pub. No.: US 2023/0325954 A1
(43) Pub. Date: Oct. 12, 2023

(54) SYSTEMS AND METHODS FOR FACILITATING EDUCATION

(71) Applicants: Gabriel Leon, Boulder, CO (US); Maria Jose Tamayo y Ortiz, Boulder, CO (US)

(72) Inventors: Gabriel Leon, Boulder, CO (US); Maria Jose Tamayo y Ortiz, Boulder, CO (US)

(21) Appl. No.: 18/321,377

(22) Filed: May 22, 2023

Related U.S. Application Data
(60) Provisional application No. 63/322,349, filed on Mar. 22, 2022.

(51) Int. Cl. G06Q 50/20

(52) U.S. Cl. CPC G06Q 50/2053

(57) ABSTRACT

A system and method for facilitating online education. The system provides for forming mentor groups that have desired mentor-mentee ration. The system can periodically check out for student dropouts from different courses and rearranges the mentor groups based on the dropout information.

### CROSS-REFERENCE TO RELATED APPLICATIONS

This application claims priority to the U.S. provisional patent application Ser. No. 63/322,349, filed on Mar. 22, 2022, which is incorporated herein by reference in its entirety.

### FIELD OF INVENTION

The present invention relates to a system and method for facilitating education, and more particularly, the present invention relates to a system and method for facilitating affordable education.

### BACKGROUND

Higher education inherently provides better access to opportunity as evident from the higher unemployment rate of young workers without a degree. Furthermore, in the US, the incidence of poverty is higher among those who only hold high school diplomas. The proportion of opportunities for graduates is significantly more than the diploma holders. There are a variety of reasons that students could not have access to higher education. High cost is the primary reason for higher education to be out of reach for many. In developing countries, various challenges for higher education include corruption, infrastructure, faster population growth than in OECD countries, and large student-to-teacher ratios. A more educated society has inherent value beyond just the above demands. For instance, technological progress has been known to be related to the expansion in education and increased opportunities for more people.

Besides higher education, poverty affects the adequacy of quality of primary and secondary education. Gender roles and gender discrimination depending on the country of origin is another major factor limiting access to higher education. Disability, political stability of a country are a few other reasons.

The explosion of online education has long held the promise to remedy the above-described challenges, and in particular, the challenges associated with scalability. However, this has not been the case thus far. One of the main reasons for this shortcoming has been the low retention rate of online courses. Most massive open online courses (MOOCs), online bootcamps, and even some online college programs do not involve interacting frequently with faculty members and other students. This has been shown to be a key factor in student retention. The quality of the course contents has been found to be instrumental for student retention in all types of courses. Students in several studies report that not being able to resolve open questions in what they consider a reasonable timeframe decreases their motivation to continue with such courses. Similar problems and challenges exist with other online models currently in place, such as bootcamp model.

A need is therefore appreciated for a novel educational system that overcomes the above-described drawbacks and challenges with digital education platforms.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method that overcomes most of the challenges in accessing quality higher education.

Another object of the present invention is that the system can offer education/training to arbitrarily large populations of learners.

It is still another object of the present invention that the cost of education can be significantly reduced.

It is yet another object of the present invention that the system can be easily scaled up.

It is a further object of the present invention that the required mentorship can be provided to the students.

It is still a further object of the present invention that the carrier services can be provided at end of the program.

In one aspect, the disclosed system can provide for collaborative learning and learning by teaching. The disclosed system uses collaborative learning extensively to both provide learners with all the aforementioned benefits as well as to help solve the issue of scalability. Learning by teaching is a form of collaborative learning that encourages learners to learn a subject and then teach it as part of the educational experience. Systematic and required use of learning by teaching is a key ingredient of how the invention solves the problem of scalability, and at the same time provides learners with unique learning opportunities.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram illustrating the authentication service, according to an exemplary embodiment of the present invention.

FIG. 2 is a block diagram illustrating the message service, according to an exemplary embodiment of the present invention.

FIG. 3 is a block diagram illustrating the educational credentials validation service, according to an exemplary embodiment of the present invention.

FIG. 4 is a block diagram illustrating the meet service, according to an exemplary embodiment of the present invention.

FIG. 5 is a block diagram illustrating the search service, according to an exemplary embodiment of the present invention.

FIG. 6 is a block diagram illustrating the user service, according to an exemplary embodiment of the present invention.

FIG. 7 is a block diagram illustrating the dropout service, according to an exemplary embodiment of the present invention.

FIG. 8 is a block diagram illustrating the group formation service, according to an exemplary embodiment of the present invention.

FIG. 9 is a block diagram illustrating the admissions service, according to an exemplary embodiment of the present invention.

FIG. 10 is a block diagram illustrating the course material service, according to an exemplary embodiment of the present invention.

FIG. 11 is a block diagram illustrating the assessment service, according to an exemplary embodiment of the present invention.

FIG. 12 is a block diagram illustrating the student service, according to an exemplary embodiment of the present invention.

FIG. 13 is a block diagram illustrating the course administration service, according to an exemplary embodiment of the present invention.

FIG. 14 is a schematic diagram showing an overview of the system, according to an exemplary embodiment of the present invention.

FIG. 15 is a block diagram illustrating an architecture of the system, according to an exemplary embodiment of the present invention.

FIG. 16 illustrates an example of learning by teaching, according to an exemplary embodiment of the present invention.

FIG. 17 shows an example group formation, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

With regards to the diagrams, the drawn connections between databases are for entity-relation visualization purposes only. In actual, there may be no direct connection between the databases. Every service may manage its own data. Therefore, access to said data is only possible by going through the corresponding microservice.

The term service herein after refers to a set of instruction, software, tool, code, and the like which upon execution by the processor performs one or more steps of the disclosed methodology. The service may take certain requests and/or inputs and returns corresponding outputs. Typically, the services are categorized by the types of tasks they perform. Within a software, there can therefore be e.g., a single service that performs a single task, or multiple distinct services that work in unison to fulfil the requirements of the software, which are determined in step 1. If the former is the case, the problem is referred to as depth oriented. If the latter is the case, the problem is referred to as breadth oriented. Additionally, in the latter case the services are conventionally referred to as microservices. For each (micro)service, in this step key functions are described, as well as what and how data is being stored. This step illustrates the way key functional requirements are fulfilled. This includes data management and data exchange within each (micro)service.

The disclosed system can include functional aspects and non-functional aspects for implementing the invention. The functional aspects are the key features of the invention which upon execution by the processor performs one or more steps of the disclosed methodology. The non-functional aspect are the conditions under which the software should perform the functional requirements. These include constraints and scalability considerations.

The term service or microservice hereinafter refers to a set of instruction, code, or a software which can be executed by the processor to perform one or more prescribed functions. The terms module and service and micro-service are interchangeably used herein after.

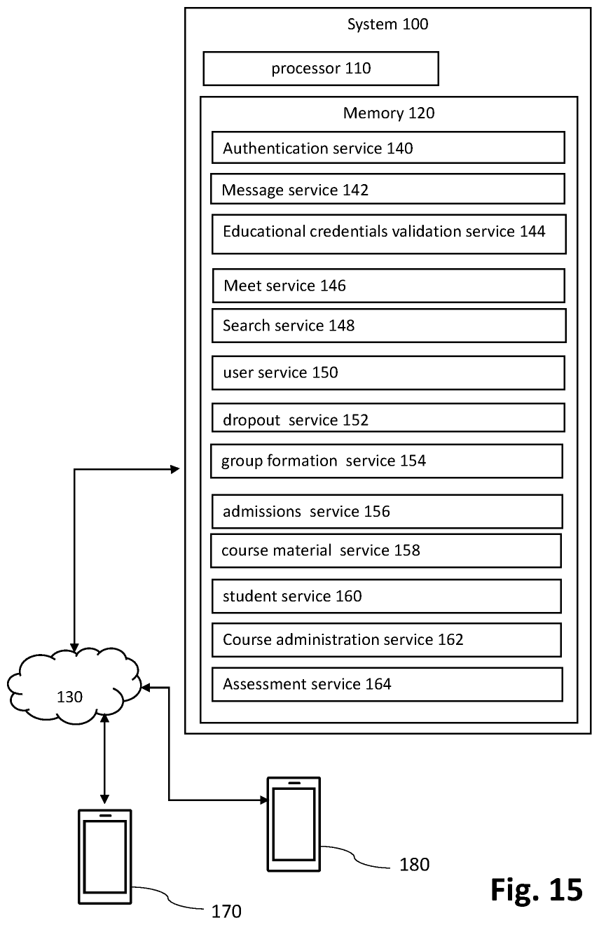

FIG. 15 is a block diagram showing an environment and an architecture of the disclosed system 100. The disclosed system can include a processor 110 and a memory 120. The processor can be any logic circuitry that responds to, and processes instructions fetched from the memory. The memory may include one or more memory chips capable of storing data and allowing any storage location to be directly accessed by the processor. The memory includes services according to the present invention for execution by the processor to perform one or more steps of the disclosed methodology. The disclosed system can also connect to an external network 130. The network may be a wired network, a wireless network, or may include a combination of wired and wireless networks. Examples of the network includes LAN, WAN, cellular network including 3G, 4G, and 5G, and the like. The memory can include different services for execution by the processor to perform one or more steps of the disclosed methodology for facilitating online education. System 100 can connect to different user devices through a network. The user can be any person interacting or wishing to interact with the disclose system through their user devices. The user can be a student, a teacher, a course administrator, and the like. FIG. 15 shows a student device 170 and a teacher device 180 connected to the system 100 through network 130. It is understood, however, that different user devices can connect to the disclosed system through different networks, and same user device can connect with the disclosed system through more than one network. Also, different user devices can connect with the disclosed system simultaneously or at different times.

The disclosed system can be implemented in the form of one or more servers that include cloud servers. The servers can be located at one place or geographically dispersed. Also, it is understood that the system can be optimized for an acceptable level of uptime based on the demand of the users and the service processes. For this, the servers can be distributed across different geographical regions. Required security measures to prevent any potential threat to functionality and data storage is also within the scope of the present invention.

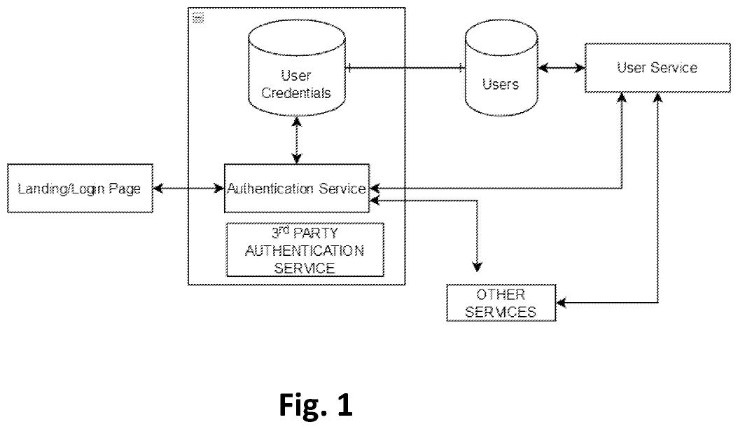

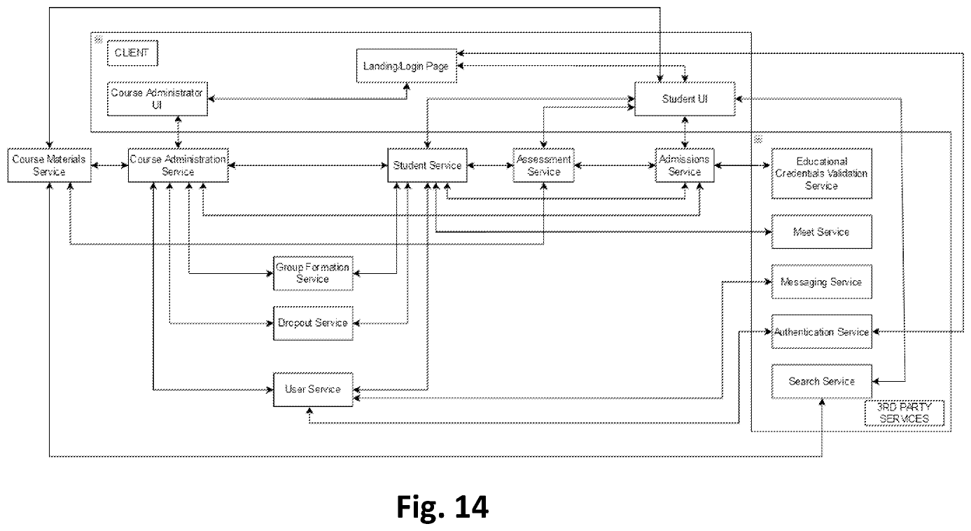

Drawing in FIGS. 1-14 shows the high-level logical architecture of the disclosed system. This means providing a block diagram with one block for each (micro)service, with indicators within the diagram of the data/logic flow between them. The purpose of this step is to provide a summary of how the (micro)services work in unison to fulfill all functional requirements of the disclosed system 100. FIG. 14 shows an overview of the disclosed system.

### Non-Functional Requirements

The following non-functional requirements are not meant to be an exhaustive and complete list of requirements. This is because unexpected considerations may arise when users begin using the platform, or whilst software engineers and testers build the platform. This is a common occurrence in software development and is expected. However, there are some general guidelines that one can plan for, and these are listed in this sub-step.

NUMBER OF STUDENT USERS: Because of the scalable nature of the disclosed system, as well as its potentially low cost, it should be expected that around 5 million active students can register with the disclosed system.
NUMBER OF COURSE ADMINISTRATOR USERS: In certain implementations, it can be assumed that there can be around 150,000 users that are course administrators.
AVAILABILITY VS. CONSISTENCY: CAP theorem states that it is impossible for a distributed system to simultaneously provide all three of the following guarantees: consistency, availability, and partition tolerance. Depending on the data that needs to be accessed, one can prioritize different goals. If a choice needs to be made between the availability and consistency with regards to student progression, consistency is likely preferable. In data such as course material, high availability is preferable. This is because it is more important for students to access course material quickly than it is for every student to have the most up-to-date course materials.
DATA ACCESS: There may be courses that are highly popular. On top of this, some groups within a cohort of students may be of a significant size. This means that, for example, many students may, e.g., request the same course materials at the same time. For reasons such as this one, hotspots are expected when retrieving this type of information. The same can be said about assessments and other data that is frequently utilized by students.
MENTOR GROUP RE-ARRANGEMENTS: Student dropouts and group formation at the beginning of each unit should complete within a reasonable timeframe, especially student dropout handling.
COMMUNICATIONS AMONGST STUDENTS: Because of the collaborative nature of disclosed system, it is expected that all students may maintain near-daily communications with other students. This means that for each student, it is reasonable to expect multiple messages sent and received on a daily basis. An arbitrary initial assumption could be that each active student sends 100 messages per day, thus resulting in, referencing non-functional requirement 1, 500 million daily messages. It is also expected that there could be daily video calls per mentor group. This means that the number of daily video calls could be in the order of 5 million.
WORLDWIDE DISTRIBUTION: Because this design is for an online platform, there may be students from all over the world. For this reason, it is desirable for students and course administrators to have similar user experiences regardless of their locations.
SECURITY OF USER DATA: Both students and course administrators should have secure account access. This is especially true of course administrators, as some may be in control of courses that are taken by a very large number of students. Measures such as multi-factor authentication can help strengthen security, and are, at time of writing, a gold standard when it comes to online account security.
PLATFORM LATENCY: 100 ms is typically regarded as an acceptable response time, so such latency should be approximated as much as possible. The same should be true for any 3rd party service used.
THROUGHPUT: Throughput may be very high for certain types of requests, such as viewing a certain unit's notes, sending messages to other students, auto-grading of assessments, etc. This may vary according to the time of day. The system should therefore be resilient to such level of throughput whilst still delivering an acceptable user experience. The throughputs may be based on the assumption that there are 5 million daily active students, and 150,000 course administrators. For e.g., assuming each student takes one assessment daily, and these are spread equally throughout the day, then there may be 5 million/(24 hours/3600 seconds) ˜60 assessment evaluation requests per second, though this is an average. There may be times when there are more evaluation requests. For this reason, round up to 200 evaluation requests per second during peak traffic times.
READ-WRITE BALANCE: Certain items in the database may be read far more than they are written on, such as course notes. However, other items may be written on par with how much they are read, such as assessment results. Such balances need to be determined on a per-microservice basis, so that solutions such as replication, sharing, etc. can be put in place.
VOLUME OF DATA STORED: Given the potential number of users and courses, and the fact that each user may generate multiple items of data of different types with multiple fields each, an approximate data volume is difficult to estimate. However, modern databases are not limited by the volume of data stored but rather by the computational complexity of queries and indexes. These limits are unlikely to ever be hit, and various remediation strategies are available when bottlenecks become apparent. As non-functional data storage requirements differ significantly based on the data types and access requirements, strategies may be determined on a per-microservice basis.
Batch processing: At the end of each unit, students are evaluated, and progress determined accordingly. They are also arranged into mentor-mentee groups. This is an operation that is to be performed to all active students. For this reason, parallelization may help speed up this process so that students don't have to wait a long time to see what their next unit will look like. The degree of parallelization is to be determined using the expected number of active users. E.g., horizontally scaling the corresponding microservices may help remedy the issue.
DEPTH VS. BREADTH: Because of the various distinct functionalities that disclosed system has, such as sorting students, detecting dropouts, performing assessments, etc, it makes sense to use a microservice architecture, making this a breadth-oriented problem.

### Defining the Microservices

Various microservices and their associated data models can be described. Note that functions that retrieve/write/alter data from the microservice's data store are mostly not included, but their existence is implied. The way these key functions are described is by a function name, conventionally written in snake case (e.g., name_of_function), followed by a parenthesis inside which is a high-level description of what information needs to be provided to the function. Then, a high-level description of what the function does is given.

Referring to FIG. 1, which illustrates the Authentication service 140 that allows visitors to the website/platform to create new user accounts and log into existing user accounts. Users may be course administrators and/or students. There are many pre-built authentication services that are known to be highly secure, and which include credentials storage, multi-factor authentication, OAUTH token capacity, the ability to use provided authentication tokens to verify the identity of users in other user-restricted backend microservices, built-in data volume scalability solutions, and more. The access to information considered sensitive or accessible only to select users is implied to require authentication by such authentication provider, and going forward, such checks are implied and not explicitly drawn out, as such decisions will be made by those who implement this design. The database managed by the 3^{rd} party authentication service could house the credentials and user ID. Such user ID can be a foreign key in, e.g., a relational database table for user information (managed by the User microservice, which is describe later) whose fields could include user ID, name, last name, type of user, etc, with a one-to-one relation. For all the above reasons, two most basic functions of this service include first, create user (identifying user details, including password): Creates a user record in the user's database and corresponding credentials record in the 3^{rd} party authentication service. This allows said user to log into their student/course administrator portal from that point forward. Another is login (user credentials): Allows a user to log into their student/course administrator portal, that could e.g., create a user session that allows the user to make authenticated requests to other microservices that so require, via, e.g., JSON Web Tokens (JWTs).

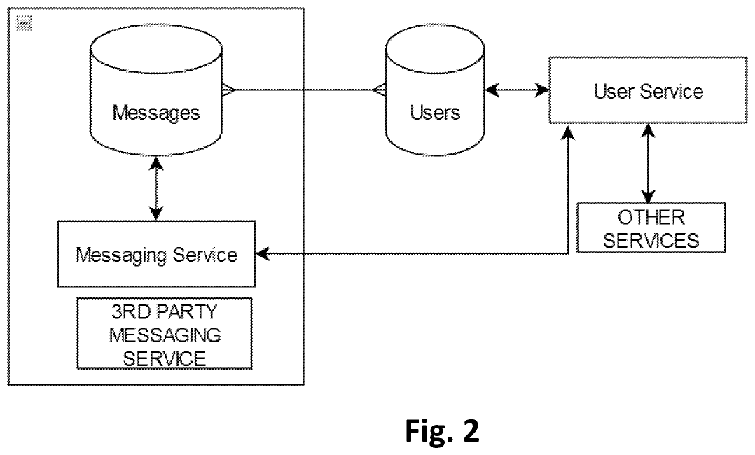

Referring to FIG. 2 which illustrates the messaging service 142 which is responsible for announcements, student notifications, communications amongst students, and communications between course administrators and students. There are various pre-built messaging services that can satisfy this need as well as handle the scaling required and is therefore the simplest method for implementing the microservice. One way to manage the data the microservice handles would be for the message records to pertain to the users involved in the messages, so that the message records reference the user IDs of the users involved, making the relation between messages and users many-to-many. If the 3rd party messaging service uses document-based storage, no join tables are necessary, as each message record can contain a variable amount of user IDs. Optionally, it is also possible to use instantaneous communication tools such as web sockets, not explained further. This microservice has only one important function besides CRUD operations: send_message (message, recipients and type of message): Sends a message of the specified type to the specified recipients.

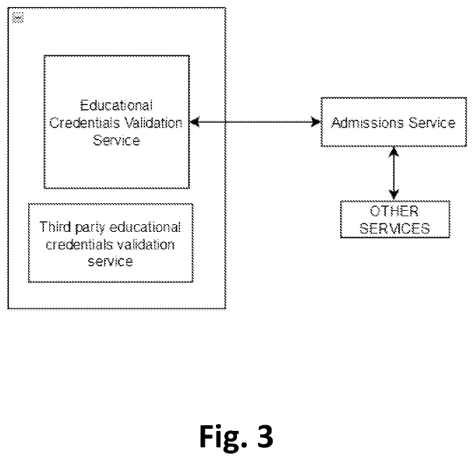

Referring to FIG. 3 which illustrates the Educational Credential Validation service 144, the purpose of this microservice is simply to verify whether required credentials for admission of prospective students into certain courses are present. This may be a 3rd party service, such as Coursera (e.g., verifying whether a prospective student's provided required credential identifier is valid). Requests can be made by the admissions microservice, which is described later. It may have one key function: verify_eligibility (course ID, prospective student credentials): Given a course ID, checks what credentials are required, and validates the credentials.

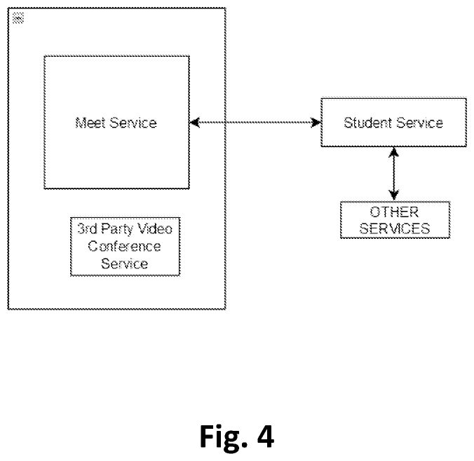

Referring to FIG. 4 which illustrates the meet service 146. Like the authentication and messaging, meet can be a service provided by an external library, for which there may various viable options. Its purpose is to facilitate video calls between mentee-mentor groups, track attendance, and (optionally) make the recording of calls available to students/course administrators for future reference. Because it would be an external service, it would have its own data store which can be made available to the students through a variety of different means, which are outside the scope of this patent. Requests may be the made by the student microservice. There may be three main functions to fulfil: create_meeting (users invited and meeting time): creates a link or otherwise where students can meet; get_meeting_details (meeting ID): retrieves information about the meeting, such as attendees; and see_meeting (meeting ID): stream or download the recording of the meeting.

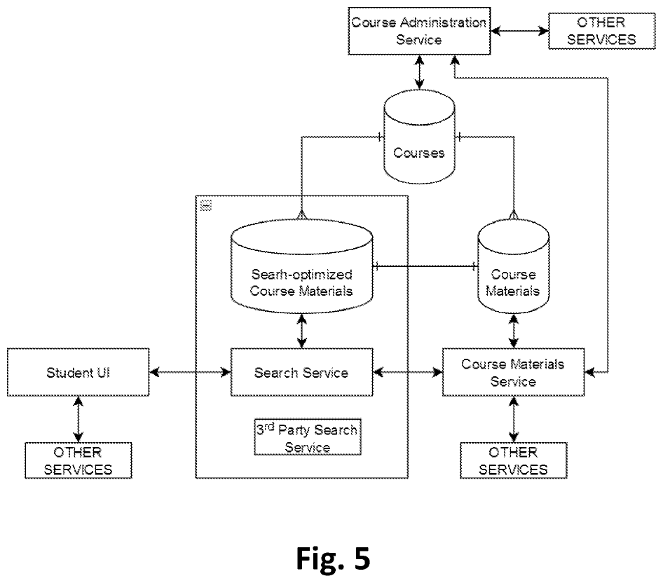

Referring to FIG. 5 which illustrates the search microservice 148, and how it interacts with the client side, as well as the course materials microservice. The relevant data relationships are also illustrated. The search service enables visitors and users to search courses that may entice them to begin their learning experience. Like the authentication, one can adapt and connect the system with relative ease to one of the many full text libraries in existence that can interact with the database. Search can be initiated by the client, and the search service has, e.g., a replica of the course materials and what courses these relate to. This data is stored such that it is optimized for full text search via e.g., appropriate indexing. The course materials are requested to be replicated in such fashion periodically by the course material microservice. Though the search-optimized course material storage strategy may differ from how the course materials are stored in their corresponding microservice, the relationship remains one-to-one. Additionally, both data have a many-to-one relationship with the course records, which store individual courses' metadata. These are distinguished from course materials records, which house the content of units of a course. The courses' data store is managed by the Course Administration microservice. There may be one key function in this service: search (text): given some text, returns a list of courses with an excerpt containing the search query. The result ordering can be specified via criteria allowed for by the third-party service and software implementation. This function may interact with tables beyond just the courses table, e.g., with the course material table to find better matches.

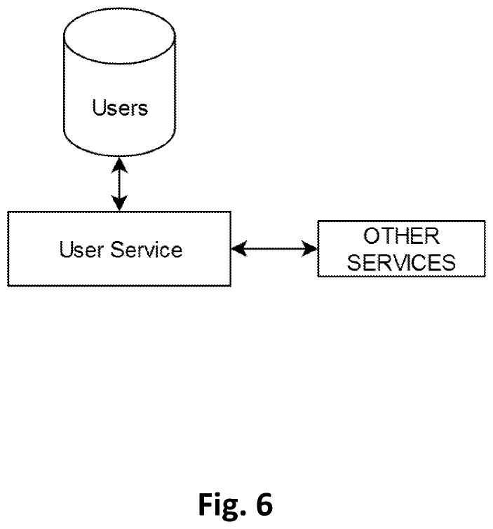

Referring to FIG. 6 which is a high-level illustration of the user service 150. The user service can manage creation, reading, updating, and deletion (CRUD) of users' information per the permission level of the requester. This microservice contains no special functions other than permission-based CRUD operations for one or multiple users, as well as interacting with the Messaging and Authentication services described above. It further interacts with the Student and Course Administration services, as these can request information from this service's storage layer, e.g., a course search may display information about a course, but also its course administrator, in which case the users data can be queried.

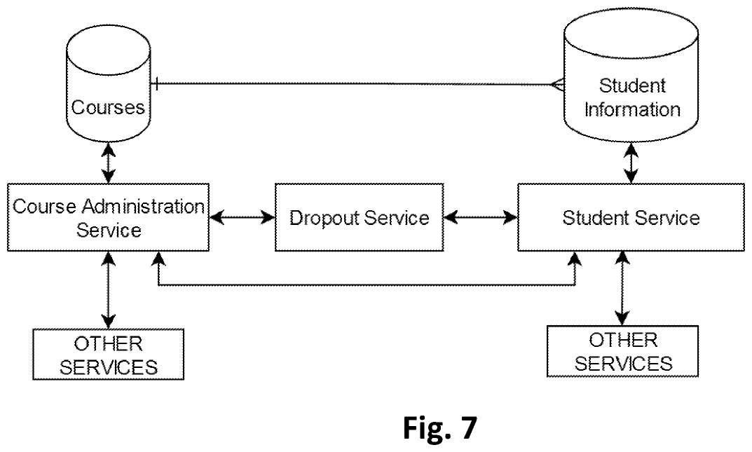

Referring to FIG. 7 which illustrates the Dropout service 152 and its interaction with the Course Administration service as well as the Student service per the above description. The dropout service can identify dropout students from all courses and sends dropout information to the student microservice for dropout processing. Although it is true that a single user can be a student in many courses, a user has a single student record per course they are taking. This microservice may have one key function which runs periodically: check_for_dropouts (course ID): Queries the Course Administration microservice (described later on) to check active courses and their retention criteria, then queries student microservice (also described later on) for all student information on these courses. It then uses the retention criteria of each course to decide which of each courses' students are to be considered dropouts. The student IDs of the dropouts are then sent to the student microservice for updating its student records, including any mentor group re-arrangements that may be necessary.

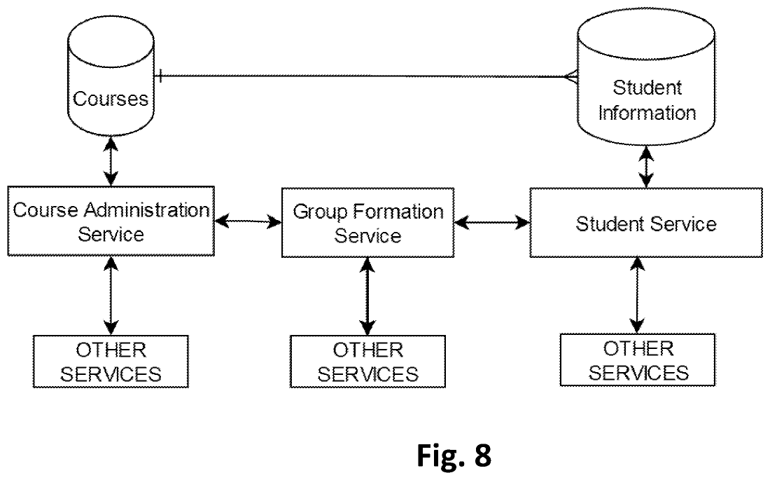

Referring to FIG. 8 which illustrates the Group Formation service 154 and its interaction with the Course Administration microservice as well as the student microservice. The Group Formation service can handle mentor group arrangements at the beginning of each unit, and also handles mentor group re-arrangements that may be necessary due to dropouts. This microservice may have two key corresponding functions: arrange_mentor_groups (course parameters): Periodically prompted by the Course Administration microservice (described later on), this function arranges mentor groups for all students per the course parameters (e.g. mentee-mentor ratio, distribution strategy, etc.), then sends a corresponding request to update students information to the Student microservice; and re_arrange_mentor_groups_for_dropouts (course ID and student IDs of the course in question): Prompted by the Student microservice as per the information it receives from the dropout microservice, and informed by the Course Administration microservice regarding dropout re-distribution strategy for the course in question, this function re-assigns mentor groups for students affected by dropouts.

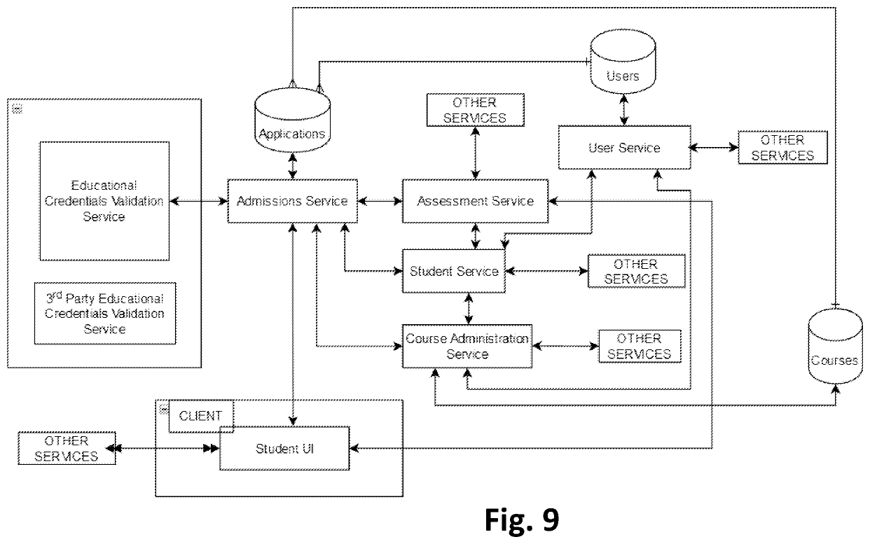

Referring to FIG. 9 which illustrates the admissions microservice 156 and its interaction with its associated microservices. The admission service can be accessible via the client and its purpose can be to coordinate the process of admission of a user into a given course. The general admissions flow (which can be variable, and this flow is merely an example): (a) begins by a user requesting admission into a course, The Admissions microservice can then query the Course Administration microservice for it to provide the course requirements, e.g. skill assessments or prerequisite courses, The Admissions microservice can then present an application form for the user and prompt the user for prerequisite course completion; (b) When the user provides proof of prerequisite course completion, the microservice queries the Educational Credentials Validation microservice and relays the verdict back to the Admissions microservice, which can then update the application record; (c) If there is an assessment requirement for the candidate, the Admissions microservice retrieves the assessment ID from the Course Administration microservice, and asks the Assessment microservice (described later on) to serve the corresponding assessment to the user; (d) The user can then submit the assessment back to the assessment service which automatically grades the assessment and relays the information back to the Admissions microservice, which updates the application record and notifies the client; (e) Once these requirements can be fulfilled, the Admissions microservice updates the application record and requests the creation of a student record with the corresponding course ID. It should be noted that the applications have a many-to-one relation with courses (via e.g. course ID), and a many-to-one relation with users (via e.g. user ID).

Correspondingly, the key functions are the following: begin_admission (user ID and course ID): Described in (a); validate_credentials (credentials and application ID): Described in (b); administer admission_test (application ID): Described in (c); evaluate_admission (application ID and admission test result): Described in (d); and approve_admission (application ID and admission test result): Described in (e).

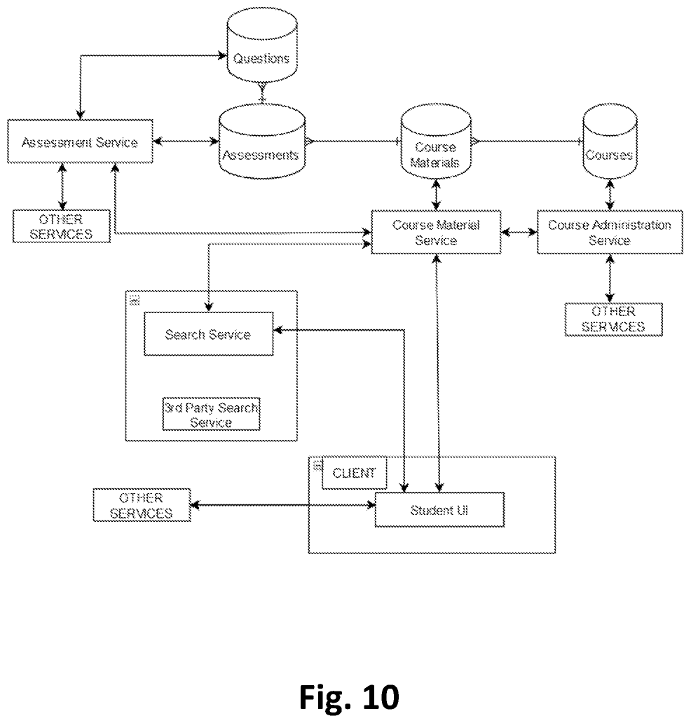

Referring to FIG. 10 which illustrates the Course Material microservice 158 and its interaction with other services. The course material service provides the students with the course materials they are allowed to access per their course progressions/course enrolments via the Course Administration microservice 162. A course administrator that manages a course can make amendments or additions to course materials (and assessments if so desired) via this microservice. Course materials can be arranged such that a single record is the course material for a single unit. The usage of a document-based database may be advantageous as it could simplify versioning, which can facilitate aspects such as traceability. The course material storage has a many-to-one relation with the courses storage, as each course can have many units, and some course materials may be deprecated. Records could have fields such as course ID, content, etc. This data is also related to assessments via the corresponding microservice, for which there are many assessments per course material (so assessments would need a foreign key for course material ID), and in a similar manner, a storage for assessment questions, also managed by the assessments microservice, has a many-to-one relationship with assessments. The functions of this microservice are simple CRUD operations, including modifications/additions to assessments that can be forwarded to CRUD operations to the corresponding assessments microservice.

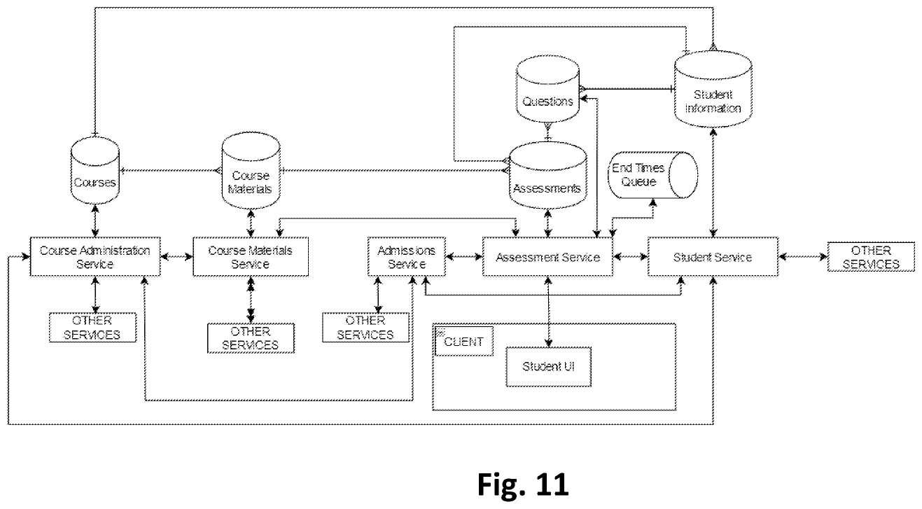

Referring to FIG. 11 which illustrates the Assessment microservice 164 and its interaction with other services. The assessment service can be accessed from the UI for direct access. This microservice manages CRUD operations regarding assessment data (including questions, as discussed before). It is also responsible for automatic grading of assessments, including admissions tests, as described above. This microservice also interacts with the student microservice 160 in order to update the student information of a student that passed/failed/got a certain grade in their assessment. It further interacts with the Course Materials microservice, as the course administrator may set or update assessments and respective assessment questions, as described above. The data model for this microservice can be described as follows: Assessment records have a one-to-many relationship with questions via, e.g. assessment ID, student information has a one-to-many relationship with assessments and questions via, e.g. their IDs (student results can be stored in the student information data store, especially if a document-based database is used for it), and as has been described above, student information records have a many-to-one relationship with courses via, e.g. course ID. Besides basic CRUD operations, this microservice performs two key functions First, begin_assessment (assessment ID): Serves the assessment, records the start time of the test and using the assessment record's time limit, calculates the end time. The end time is placed in a chronologically triggered and chronologically ordered message queue (end times queue, for which one could use a third-party library for implementation and built-in scalability), which is to trigger the end_assessment function once the end time is reached. Second, end_assessment (answers to assessment and assessment ID): If this function is triggered by the end times queue, the assessment is automatically failed, a request to update the student information is sent to the Student microservice, and the client is notified. If the user does manage to finish the assessment before the allowed time has ended, the service can check the provided answers against the relevant records in the related assessment questions records, grade the assessment, accordingly, send a request to the Student microservice, and notify the client about the result.

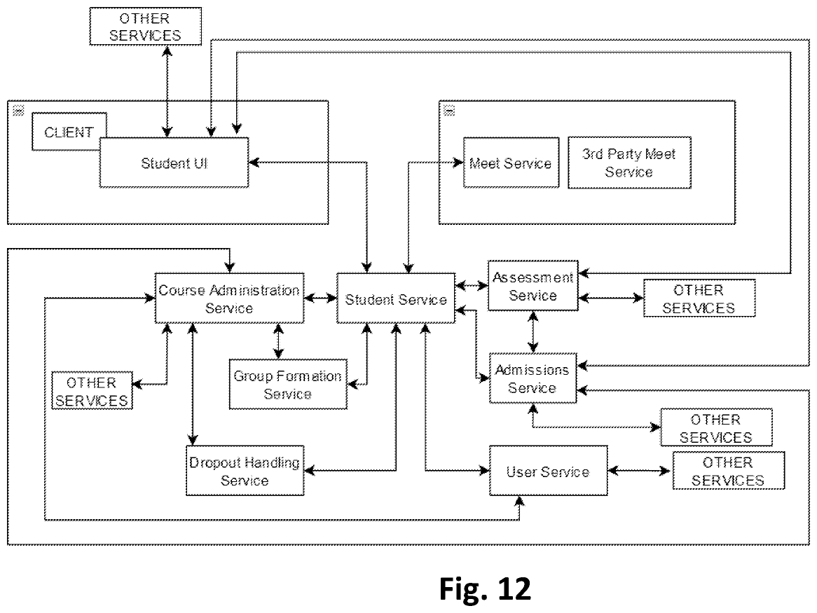

Referring to FIG. 12 which illustrates the student microservice 160 and its interaction with other services. The student service can perform crucial tasks such as updating student information (related to a student's progression in a certain course) as they take assessments, get assigned mentee-mentor groups, whether they have dropped out, the unit they are coursing, etc. This service manages CRUD operations to the student information in courses. Because of the variable number of units, a course may have, it would be possible to remedy the issue of grades obtained on each unit by storing this data in a document-based store, whose fields could include user ID, course ID, grade obtained in X unit, student status, mentor of, current unit, has graduated, etc. As has been explained above, there may be a many-to-one relation with user ID, and a many-to-one relation with course ID. As has been explained above, checking for dropouts, as well as creation and rearrangement of mentor groups can be handled by specialized microservices. Updates to student data as it relates to the courses in question can be triggered by the Course Administration microservice, which orchestrates timed events that apply to all students in a course as it progresses, as is seen in the Course Administration microservice description below. Since all interactions between this microservice and other microservices are laid out in the respective microservices' descriptions except Course Administration, we do not describe these interactions further. It is worth noting that the main CRUD operation, as it is used by many of the microservices that communicate with this microservice: set_students_information (changes desired in students information): Can create a new student information, or e.g. update the unit where a student, or many students are coursing, who their mentor is as per a shuffling strategy selected at software implementation stage, whether they have dropped out, whether they have graduated, etc. In the event of dropout updates, requests are sent to the group formation service in case rearrangements are necessary. Meeting links and schedules are recorded in student records as well.

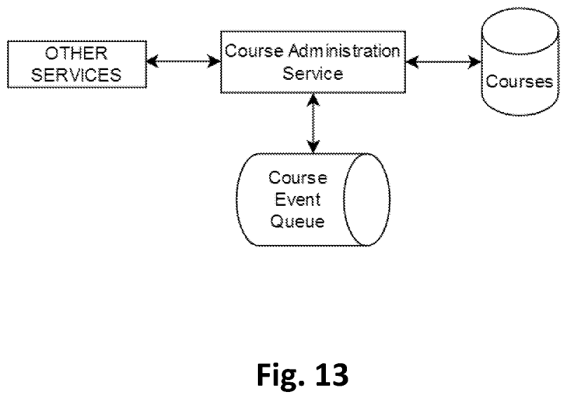

Referring to FIG. 13 which illustrates the course administration service 162. The course administration service enables course administrators to manage the courses they have created. This includes actions such as course creation and alteration. The data model stored in this microservice's store relates it to courses, storing fields such as course ID, course name, course administrator ID (which could just be the user ID), number of units, minimum number of students in the first group, mentee-mentor ratio, minimum mentee pass rate for mentors to pass, course status, dropout criteria type, mentor-mentee rearrangement strategy type, etc. This microservice also has a chronologically ordered message queue (for which one could use a third-party library for implementation and built-in scalability) that triggers events that need to occur at certain times to make sure that disclosed processes are performed in a coordinated manner. Such events, include opening a course for admissions, closing admissions for a course, beginning time of new units for students, ending units for students, and other coordinated events. When events are triggered, corresponding requests are made by this microservice to the relevant microservices. The queued events provide an event type and a time the event should be triggered. Similarly, to the Assessments microservice, the event record can e.g. be put in a cache queue that is ordered chronologically by a timestamp, representing the time at which the event should be triggered. This cache queue could e.g., be implemented using a key-value store where the key is a timestamp (up to a time resolution that is to be determined by those who implement the software), and the values are the events that should be triggered. The queue is continuously emitting events if there are any at the given time. Upon a successful response from the requests sent to the relevant microservices, the triggered events in the key-value store could then be disposed of. Conversely, events can be overridden by course administrators. This microservice performs several key functions. First, set_course (course information): Creates or updates a course with all required information ranging from the minimum number of students to the course contents and dropout criteria type. Second, set_course_lifecycle (course lifecycle information): Updates the current state of the course or sets scheduled state changes. For e.g., initiate, end, or open admissions for the course. Third, schedule_event (event information and event trigger time): Creates a new event, sets a keyword for it that gives this microservice the information it needs to make the right request to the right microservice, and stores it in the corresponding timestamp key within the events store. This function is triggered automatically upon commencement of a course, scheduling events such as beginning of units, group re-shuffling, dropout check scheduling, etc. Fourth, trigger_event (event keyword): Runs for every keyword found when the service is continuously polling to check if there is anything scheduled to run on the current time. Depending on the keyword, this service will send the relevant request to the relevant microservice. The microservice then executes the request and can return a success or failed response. If the request fails, the event is rescheduled for a nearby time in order to try again. The event keyword could contain information about the number of retries in order to optionally notify the course administrator that the corresponding request has not been able to have been performed, though such failover functionalities are up to the implementers of the software and are outside the scope of this design. Once the event is successfully triggered, the event is discarded from the cache store, and it is also updated on disk if so desired. Fifth, cancel_event (event information): Discards an event from the cache store, finding it by re-generating the keyword and searching for it.

Referring to FIG. 14 which illustrates an architecture of the disclosed system and shows interactions between different services. illustration of the student microservice and its interaction with its associated.

TABLE 1
Scalability issues solved by the system.

| Scalability | | |
|---|---|---|
| Aspect | Issue(s) | Remedies |
| Data | Can be large, depending on | Sharing using consistent |
| | how much information is | hashing can help store more |
| | stored on each user record, | data and prevent hotspots. |
| | as we expect around 100 | Replication can provide |
| | million users. | backups if there are server |
| | | failures, and further help |
| | | remedy hotspots. |
| Throughput | Around 2 million users are | Used in conjunction with the |
| | assumed to be seeing their | above referenced |
| | information several times | replication, a cache layer |
| | per day. Much more reads | that scales automatically |
| | than writes are assumed. | with traffic and also has e.g., |
| | | an LRU data eviction policy, |
| | | we can manage resources |
| | | whilst optimizing for |
| | | throughput. Additionally, a |
| | | signal for explicit cache |
| | | invalidation ensures that old |
| | | data is not presented to the |
| | | user. |
| Latency | Requests, once received, do | In addition to the above |
| | not take a long time to | remedies, using replication |
| | process. | distributed across the globe |
| | | using e.g. DNS geographic |
| | | load balancing can improve |
| | | latency. For static files, e.g. |
| | | profile photos, a content |
| | | delivery network is used to |
| | | maximize the delivery speed |
| | | to the user. |
| Availability | Availability. Users should | Leader-follower strategy for |
| vs. | not have to wait a long time | writes on replicas ensures |
| Consistency | for their, or others' profile | eventual consistency whilst |
| | information to load. | maximizing availability. |
| | | Due to infrequent changes |
| | | to the user data it is unlikely |
| | | that stale data is presented |
| | | to the user. |
| Geolocation | Preferable for improving | Using replication distributed |
| | latency. | across the globe using e.g. |
| | | DNS geographic load |
| | | balancing ensures servers |
| | | that are reasonably nearby |
| | | will serve requested |
| | | records. |
| Hotspots | Likely. Some users may be | Cache solution presented |
| | very popular, e.g. course | for the throughput issue will |
| | administrators of popular | help alleviate this issue. |
| | courses, and there may be | |
| | many read requests for | |
| | them, thus creating | |
| | hotspots. | |

TABLE 2
scalability issues in Group Formation:

| Scalability | | |
|---|---|---|
| Aspect | Issue(s) | Remedies |
| Data | Should minimize | Holds identifiers for active |
| | data access | students, their status, and |
| | to Student service | their units in a temporary |
| | but does not | data structure. It should be |
| | store data on disk. | possible to hold this |
| | | information in memory—up |
| | | to 2 million entries in a hash |
| | | table to form even large |
| | | groups. |
| | | Alternatively, an optimized |
| | | temporary data structure |
| | | for the processing can be |
| | | prepared. An indexable |
| | | database could allow for |
| | | efficient matchmaking as its |
| | | data structure is designed to |
| | | find data efficiently and |
| | | quickly. |
| Throughput | On each of up to | No action is necessary for |
| | thousands of | remedying throughput. |
| | courses, Tens of | |
| | times a day re- | |
| | assigning student | |
| | that are affected | |
| | by dropouts, and | |
| | fewer times a | |
| | day re-forming | |
| | all groups in a | |
| | course. Throughput | |
| | is therefore | |
| | reasonably low by | |
| | today's standards. | |
| Latency | Group formation | We could use compute |
| | is an O(N) | replication behind a load |
| | operation, where | balancer in order to |
| | N can be in the | parallelize group formation |
| | order of millions. | across different servers, and |
| | | then return the different |
| | | groups formed on the |
| | | different servers. This will |
| | | increase redundancies as |
| | | well as reduce response |
| | | times. That being said, O(N) |
| | | operations in modern |
| | | servers could provide an |
| | | acceptable latency without |
| | | the need for parallelization. |
| | | ALTERNATIVE: A divide-and- |
| | | conquer approach to group |
| | | formation could reduce time |
| | | latency up to O(log(n)) at |
| | | the cost of more parallel |
| | | computation power. |
| | | Starting with random |
| | | clusters of mentees and |
| | | mentors these can be |
| | | matched in parallel instead |
| | | of regarding all participants. |
| | | This approach scales well as |
| | | the depth can be set to a |
| Availability | Consistency. | function of total participant |
| vs. | Users should | number. |
| Consistency | have up-to-date | When group formation is |
| | information | being performed, a cache- |
| | about their | invalidation signal is sent to |
| | groups. | the cache layer of the |
| | | Student microservice. This |
| | | allows for quick response |
| | | times while providing good |
| | | consistency. A similar |
| | | approach could be had |
| | | when remedying student |
| | | redistribution after |
| | | dropouts, but only caching |
| | | the pending signal for the |
| | | students affected. |
| Geolocation | Being a batch job, | N/A |
| | geolocation is | |
| | unimportant. | |
| Hotspots | No data to query. | N/A |

TABLE 3
scalability issues in Group Formation Dropout

| Scalability | | |
|---|---|---|
| Aspect | Issue(s) | Remedies |
| Data | Should minimize data access | Temporarily holds identifiers |
| | to Student service but does | for active students and their |
| | not store data on disk. | status. It should be possible |
| | | to hold this information in |
| | | memory—up to 2 million |
| | | entries in a hashtable. |
| Throughput | On each of up to thousands | No action is necessary for |
| | of courses, Tens of times a | remedying throughput. |
| | day identifying students that | |
| | are affected by dropouts. | |
| | Throughput is therefore | |
| | reasonably low by today's | |
| | standards. | |
| Latency | Filtering operations on e.g. | We could use compute |
| | JSON objects, resulting in an | replication behind a load |
| | O(N) operation, where N | balancer in order to |
| | can be in the order of | parallelize dropout |
| | millions. | identification across |
| | | different servers, and then |
| | | return the different groups |
| | | formed on the different |
| | | servers. This will increase |
| | | redundancies as well as |
| | | reduce response times. That |
| | | being said, O(N) operations |
| | | in modern servers could |
| | | provide an acceptable |
| | | latency without the need for |
| | | parallelization. |
| | | However, it would be |
| | | conceivable to have a |
| | | replica of the students |
| | | database such that it is |
| | | indexed to optimize |
| | | searching for dropouts. This |
| | | could improve the |
| | | performance of this |
| | | microservice dramatically. |
| | | For example, when starting |
| | | the dropout process, one |
| | | could take a snapshot of the |
| | | students data and index it to |
| | | update the more optimized |
| | | database. |
| Availability | Availability. Dropouts should | Availability is more |
| vs. | be processed as quickly as | important as the batch job |
| Consistency | possible to avoid students | must run regularly. |
| | interacting with the course | Consistency isn't of concern |
| | if they no longer are eligible | as the service does not |
| | to continue. | persist any data itself. Data |
| | | persistence is taken care of |
| | | by the Student Service. |
| Geolocation | Being a batch job, | N/A |
| | geolocation is unimportant. | |
| Hotspots | No data to query. | N/A |

TABLE 4
scalability issues in Course Materials:

| Scalability | | |
|---|---|---|
| Aspect | Issue(s) | Remedies |
| Data | Up to 150,000 courses, each | For both unit materials |
| | with tens of units, so the | stored in the proprietary |
| | number of records is in the | database schema as well as |
| | millions. Assuming that each | accompanying materials like |
| | record is on average 5 MB | PDF documents, no |
| | (this could be substantially | particular remedies are |
| | more if media data is stored, | necessary as they are well in |
| | though media could be | the realm of commodity |
| | hosted by an external | servers and databases. |
| | service), we would be | Cloud computation service |
| | storing data in the order of | providers allow for tens of |
| | 10 TB. | millions of binary files |
| | | (BLOBs) to be stored and |
| | | fetched. Automatic |
| | | replication and backups are |
| | | offered to ensure data is |
| | | held reliably. |
| Throughput | Around 2 million users are | Used in conjunction with the |
| | assumed to be seeing their | above-referenced |
| | course materials several | replication, a cache layer |
| | times per day. Far more | and CDN for binary files |
| | reads than writes are | allows data to be served |
| | assumed. | quickly while maximizing |
| | | throughput. |
| Latency | Requests, once received, do | In addition to the above |
| | not take a long time to | remedies, using replication |
| | process. | distributed across the globe |
| | | using e.g. DNS geographic |
| | | load balancing can improve |
| | | latency. If media is being |
| | | served, CDNs are used to |
| | | optimize for delivery speed. |
| Availability | Availability. Users should | Leader-follower strategy for |
| vs. | not have to wait a long time | writes on replicas ensures |
| Consistency | for their course material to | eventual consistency whilst |
| | load. | maximizing availability, |
| | | especially if using the above |
| | | suggested replication that |
| | | updates asynchronously so |
| | | that the reads always go to |
| | | the cache. |
| Geolocation | Preferable for improving | Using replication distributed |
| | latency. | across the globe using e.g. |
| | | DNS geographic load |
| | | balancing ensures servers |
| | | that are reasonably nearby |
| | | will serve requested |
| | | records. |
| Hotspots | Likely. Course materials for | Cache solution presented |
| | the lowest units will have | for the throughput issue will |
| | many more students, thus | help alleviate this issue. |
| | creating hotspots in those | Replication within the cache |
| | units' materials. | layer could further alleviate |
| | | this issue if necessary. |

TABLE 5
scalability issues in Course Administration

| Scalability | | |
|---|---|---|
| Aspect | Issue(s) | Remedies |
| Data | Up to 150,000 course | Data writing and storage are |
| | administrators and roughly | low compared to other use |
| | the same number of | cases and do not require |
| | courses. Allowing for | special handling. Replication |
| | versioned courses | can provide backups if there |
| | (traceability) may result in | are server failures, and help |
| | significantly more course | remedy hotspots. |
| | information to be stored. | |
| Throughput | Millions of users are | Used in conjunction with the |
| | assumed to be reading | above referenced |
| | course information (from | replication, a cache layer, |
| | e.g. people that use the | also with replication that |
| | course search functionality) | updates asynchronously so |
| | every day. Far more reads | that the reads always go to |
| | than writes are assumed. | the cache will better handle |
| | On the other hand, this | throughput. |
| | microservice is processing | Fair distribution of event |
| | events over up to 150,000 | consumption across the |
| | courses triggering every day. | compute replicas will |
| | | improve the way we handle |
| | | the throughput. |
| Latency | Requests, once received, do | In addition to the above |
| | not take a long time to | remedies, using replication |
| | process. | distributed across the globe |
| | | using e.g. DNS geographic |
| | | load balancing can improve |
| | | latency. This is also true of |
| | | event consumption. |
| Availability | On the data side, | Leader-follower strategy for |
| vs. | availability. Users should not | writes on replicas ensures |
| Consistency | have to wait a long time for | eventual consistency whilst |
| | course information to load. | maximizing availability, |
| | On the event creation and | especially if using the above |
| | consumption, we prioritize | suggested replication that |
| | consistency, but this is | updates asynchronously so |
| | guaranteed via | that the reads always go to |
| | implementation. | the cache. |
| Geolocation | Preferable for improving | Using replication distributed |
| | latency. | across the globe using e.g. |
| | | DNS geographic load |
| | | balancing ensures servers |
| | | that are reasonably nearby |
| | | will serve requested |
| | | records. |
| Hotspots | Likely. Certain courses will | Cache solution presented |
| | have many more reads, thus | for the throughput issue will |
| | creating hotspots in those | help alleviate this issue. |
| | courses. Also, there will be | Replication within the cache |
| | times where many events | layer could further alleviate |
| | will be emitted and require | this issue if necessary. |
| | consumption. | Replication within the |
| | | compute layer will help |
| | | alleviate the consumption of |
| | | many events at one time. |

TABLE 6
scalability issues in number of users

| Scalability | | |
|---|---|---|
| Aspect | Issue(s) | Remedies |
| Data | Up to over 100 million | Sharding using consistent |
| | records if each user has | hashing can help store more |
| | enrolled in at least one | data and prevent hotspots. |
| | course. Each record can be a | Replication can provide |
| | document with all of the | backups if there are server |
| | student progression | failures, and further help |
| | throughout the course, so | remedy hotspots. |
| | assuming that there are 1 | Replication of the compute |
| | billion records, and each | layer can also help with the |
| | record is less than 1 MB, | records held in memory |
| | then the storage required | whilst aiding parallelization |
| | would be in the order of | when talking to the batch |
| | ~100 TBs. Additionally, | job services (Group |
| | many aspects of all records | Formation and/or |
| | are held in memory for | Dropouts). |
| | making requests to | |
| | microservices such as Group | |
| | Formation or Dropouts. | |
| Throughput | Around 2 million users are | Used in conjunction with the |
| | assumed to be seeing their | above referenced |
| | information several times | replication, a cache layer |
| | per day, but daily progress | can help with both |
| | in courses is also assumed, | throughput as well as |
| | meaning that we could have | consistency. E.g. As we |
| | a more even read/write | mentioned before, when |
| | ratio. | group formation (or other |
| | | operations where student |
| | | information is being altered) |
| | | is being performed, we |
| | | could add a signal on a |
| | | cache layer of the Student |
| | | microservice to obtain a |
| | | quick response that groups |
| | | are forming, thus providing |
| | | good consistency. A similar |
| | | approach could be had |
| | | when remedying student |
| | | redistribution after |
| | | dropouts, but only caching |
| | | the pending signal for the |
| | | students affected. |
| Latency | Requests, once received, do | In addition to the above |
| | not take a long time to | remedies, using replication |
| | process. | distributed across the globe |
| | | using e.g. DNS geographic |
| | | load balancing can improve |
| | | latency. |
| Availability | Consistency. Students | See Throughput remedy. |
| vs. | should have the most up-to- | |
| Consistency | date information about their | |
| | course progression, mentor | |
| | group, etc. It is acceptable, | |
| | however, to see pending | |
| | states whilst consistency is | |
| | being achieved. | |
| Geolocation | Preferable for improving | Using replication distributed |
| | latency. | across the globe using e.g. |
| | | DNS geographic load |
| | | balancing ensures servers |
| | | that are reasonably nearby |
| | | will serve requested |
| | | records. However, this could |
| | | present further challenges |
| | | on consistency. |
| Hotspots | Unlikely on individual | N/A |
| | records. Load is expected to | |
| | be more or less even across | |
| | all student records | |

TABLE 7
scalability issues in assessment:

| Scalability | | |
|---|---|---|
| Aspect | Issue(s) | Remedies |
| Data | Smaller than Course | Replication can provide |
| | Material. | backups if there are server |
| | | failures, and help remedy |
| | | hotspots. |
| Throughput | Around 2 million users are | Used in conjunction with the |
| | assumed to be taking one or | above referenced |
| | more assessments per day. | replication, a cache layer, |
| | Far more reads than writes | also with replication that |
| | are assumed (writing of the | updates asynchronously so |
| | results goes to the Student | that the reads always go to |
| | data). | the cache will better handle |
| | | throughput. |
| Latency | Requests, once received, do | In addition to the above |
| | not take a long time to | remedies, using replication |
| | process. | distributed across the globe |
| | | using e.g. DNS geographic |
| | | load balancing can improve |
| | | latency. |
| Availability | Consistency. Students | A similar pending strategy |
| vs. | should not be allowed to | than that which is taken in |
| Consistency | take assessments that may | the Student service can be |
| | be faulty. | adopted. |
| Geolocation | Preferable for improving | Using replication distributed |
| | latency. | across the globe using e.g. |
| | | DNS geographic load |
| | | balancing ensures servers |
| | | that are reasonably nearby |
| | | will serve requested |
| | | records. However, this could |
| | | pose some consistency |
| | | challenges. |
| Hotspots | Likely. Assessments for the | Cache solution presented |
| | lowest units will have many | for the throughput issue will |
| | more students, thus | help alleviate this issue. |
| | creating hotspots in those | Replication within the cache |
| | units' assessments. | layer could further alleviate |
| | | this issue if necessary, |
| | | though it would present |
| | | further consistency |
| | | challenges. |

TABLE 8
scalability issues in admissions:

| Scalability | | |
|---|---|---|
| Aspect | Issue(s) | Remedies |
| Data | Smaller than Assessments. | Replication can provide |
| | | backups if there are server |
| | | failures and help remedy |
| | | hotspots. |
| Throughput | Possibly over 2 million users | Used in conjunction with |
| | are assumed to be taking | the above referenced |
| | daily admissions tests. Far | replication, a cache layer, |
| | more reads than writes are | also with replication that |
| | assumed (writing of the | updates asynchronously so |
| | results goes to the | that the reads always go to |
| | Application data). | the cache will better handle |
| | | throughput. |
| Latency | Requests, once received, do | In addition to the above |
| | not take a long time to | remedies, using replication |
| | process. | distributed across the globe |
| | | using e.g. DNS geographic |
| | | load balancing can improve |
| | | latency. |
| Availability | Consistency. Students | A similar pending strategy |
| vs. | should not be allowed to | than that which is taken in |
| Consistency | take admissions that may | the Student service can be |
| | be faulty. | adopted. |
| Geolocation | Preferable for improving | Using replication distributed |
| | latency. | across the globe using e.g. |
| | | DNS geographic load |
| | | balancing ensures servers |
| | | that are reasonably nearby |
| | | will serve requested |
| | | records. However, this could |
| | | pose some consistency |
| | | challenges. |
| Hotspots | Likely. Admissions for | Cache solution presented |
| | popular courses will have | for the throughput issue will |
| | many more applicants, thus | help alleviate this issue. |
| | creating hotspots in those | Replication within the cache |
| | tests. | layer could further alleviate |
| | | this issue if necessary, |
| | | though it would present |
| | | further consistency |
| | | challenges. |

In certain implementations, the disclosed system can set out criteria for considering a mentee as a dropout. The disclosed system can prescribe the performance and/or attendance criteria for a mentee in order to not being considered a dropout.

The disclosed system can create groups based on the preferred mentor-mentee ratio. The disclosed system can also determine a number of students there should be in the first group to take the course. The numbers of students in the first group can be based on the available mentors and the preferred mentor-mentee ratio. However, by using the concept of learning by teaching, the disclosed invention can reach an unlimited number of learners. This means that learners can only progress through courses if, after they course a given unit, they each teach a group of other learners the unit they just coursed, with the added requirement that a specified portion of said group pass the unit. This helps in overcoming the bottleneck in scaling in convention educational networks.

The disclosed invention can be versatile in that the course administrator may alter the overall course parameters for newly admitted students. Thus, except the first group, the newly created groups can be customized based on the requirements, such as course materials, preferred mentee-mentor ratio in the groups, number of learning units in the course, passing requirements, and Minimum mentee pass rate for mentors to pass.

The disclosed system can set the required percentage of mentees that should pass a given learning unit for mentors in the corresponding mentor unit to pass. The disclosed system can receive student applications for different courses and can create or modify the general course parameters. For example, the disclosed system can form groups from admitted students such that the first group in the queue has a factor of the applicable mentee-mentor ratio more students than the group that was previously dequeued. The group after should be a factor of the same size larger than the aforementioned and so on. Assign the number of students in the first group if no groups have been dequeued. Label groups starting from g=0, next g=1, and so on.

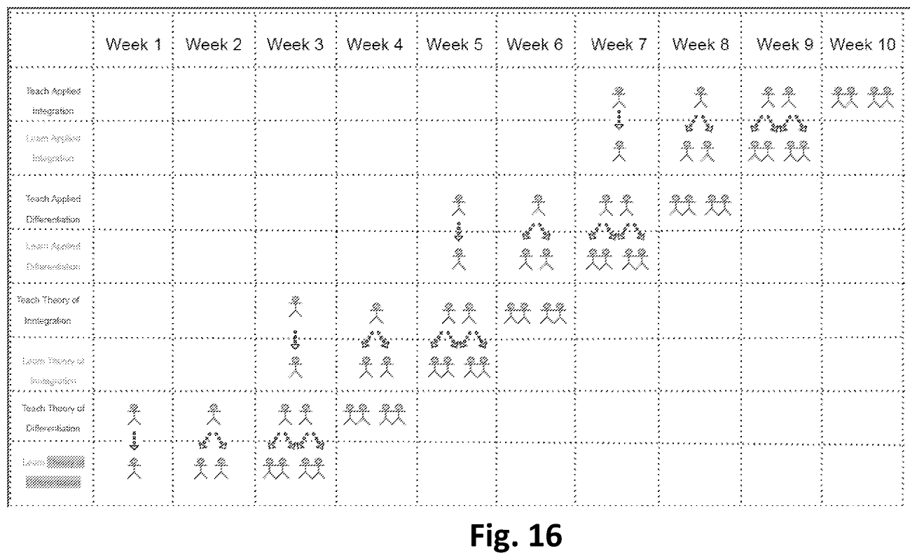

Referring to FIG. 16 which shows an exemplary embodiment of the learning by teaching. The different courses are listed on the left side and the duration of course are on the right side. The dotted arrows go from mentors to mentees. Each course unit is for one week. Any course can be started by a course administrator and the course administrator can mentor the first course unit. For example, FIG. 16 shows the course “Theory of Differentiation” is first week is mentored by the course administered which forms the first course unit. Another course unit for “Theory of Integration” starts in week 3 and mentored by the course administrator for the course “Theory of Integration”. Another course “applied integration” has its first course unit in week 7 and mentored by the course administrator. The course administrator can decide whether further admission to a specific course is allowed or not. If more students are admitted to a course, new course units can be created every week for the newly admitted students. The mentees from the first group can become mentors in the subsequently created group and this process can be continued. For example, as shown in FIG. 15, two new course units are created for the course “Theory of Differentiation”, and the mentors in second group can mentor two mentees, and these two mentees can then mentor four mentees in the third week. Thus, a student may have multiple courses/unit and the student must pass all the courses/units to be certified by the disclosed system. The student can be assigned to different course units/groups and the student at any given time can be mentee in certain course units and mentor in other assigned course units. Learning by teaching provides the learners with unique learning opportunities. Also, the use of learning by teaching is a key ingredient of how the system, also referred to herein as ACSES, solves the problem of scalability. As shown in FIG. 16, the number of students admitted to a course can exponentially increase over time while maintaining the preferred mentor-mentee ratio.

The course administrator, herein, refers to an educator that is to create, organize, and orchestrate a course offering. The course administrators can decide what the admissions process will look like. The advantage of the disclosed system is that the courses are run continuously, so the default behavior of ACSES is to leave the student applications process to run continuously so that any student can apply for the course at any time. New course units/groups can be created periodically to accommodate the new students. The course administrator has to define the admission criteria for each course. For example, the course administrator could first decide that student applications consist of a series of mathematical questions revolving around prerequisites and should be entered via an online portal. The course administrator can implement an automated grading system that each application goes through. If an application receives a grade of 75% or more, then the student is admitted onto the course. This is just an example, and different prerequisites can be set by the administrator without departing from the scope of the present invention.

In certain implementations, the course administrators can determine the dropouts in respective courses. Considering the huge student population, the disclosed system can send emails to the student periodically, such as every day, and can receive the response for the email. The student must respond to the email, such as clicking a link in the email or replying with any text within prescribed period. If no response is received by the system, the course administrator can mark the respective students as dropped out.

In certain implementations, the course administrator can configure courses by gathering and organizing course content and assessments, subdividing said content into learning units. The course administrator can decide specific requirements for passing each unit, both as mentees and as mentors; requirements that students must fulfill to remain in the course; the preferred number of students that the first group to take the course should have; the preferred mentor-mentee ratio for the course; and many other factors.

### Example

For example, the course administrator could decide to assign four week-long learning units to the calculus course: theory of differentiation, theory of integration, applied differentiation, and applied integration. Each unit has a corresponding set content, collective and individual assessments which are to be automated, and all have a passing grade of 75%, and mentors pass units if half or more of their mentees pass all their units' assessments. The course administrator also decides that in order for a student to remain in the course, they must attend all required peer meetings, once per week, and peer-with-mentor meetings, which occur twice a week. The course administrator has set up the course so that online meetings occur within the portal, and so peer and mentor attendance can be tracked, and the system can therefore mark non-attendees as dropouts. They also decide that students must present their assessments on time, or else be considered dropouts.

In this course administrator's experience, a mentor-mentee ratio of two is optimal for learning calculus. The course administrator further believes that they can mentor a single student and let ACSES do the rest, so they decide that the first group should just have a single student. The next step is for the students enrolled in the course to be arranged into groups. The first group's size shall be as close as possible to the preferred number of students in the first group as specified by the course administrator. Then, the second group shall have an equal or greater number of students than the first group, the third will have an equal or greater number of students than the second group and so on. In general, the first group as group 0, the second group as group 1, and so on until some n, then the (n+1)^{th} group shall have a factor of m students more than the nth group, where m is a number as close as possible to the preferred mentee-mentor ratio.

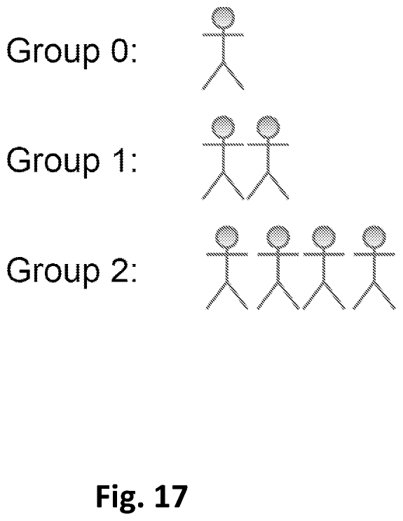

The calculus course administrator has allows for admissions to be received. By the time the course is ready to commence, there may be seven admitted students. Because the course administrator prefers a mentee-mentor ratio of two and the size of the first group to be of one student, the groups are arranged as per FIG. 17.

Once the course administrator decides there are enough students in the queue in order to begin the course, they signal that the first group is ready to begin. Before they do, the specified dropout detection process begins, and also what is called “the assignment of mentors and peers for every group” process. This process ensures that mentors are assigned to students coursing what is known as “mentee units”.

Before describing the assignment of mentors and peers for every group process any further, it should be noted that every unit has a set time interval, and it is the same and carried out at the same time as other units. By this it is meant that every group that is already taking the course shall be starting their respective units at the same time and ending them at the same time, notwithstanding that certain students may deliver the unit requirements prior to the end date of the unit. Therefore, courses are to be structured accordingly. With this understanding, the assignment of mentors and peers for every group process ensures that mentees are arranged in mentee sub-groups led by a mentor each by the beginning of every unit by every group, and according, as closely as possible, to the preferred mentee-mentor ratio, and that in the event of mid-unit dropouts, this process shall continuously ensure that mentees left without mentors and mentors left without mentees are re-assigned appropriately, keeping to the mentee-mentor ratio as closely as possible.

The course administrator can, at this point, make the final arrangements before the course begins. Namely, they activate the functionality in their online course portal that continuously monitors dropouts via the aforementioned process that they specified. They have also made an implementation in their portal to run the default version of the assignment of mentors and peers for every group process continuously.

The next step is for the first group of students to begin the course. The first group of students is to course the first unit as mentees. The first unit is known as a mentee unit. Mentee units are even-numbered units. E.g., the first unit 0, unit 2, and so on. Conversely, odd-numbered units are known as mentor units. The course administrator is to decide whether to have enlisted a supplementary mentor pool in order to mentor mentees from the first group and/or other mentees in any units left without mentors. If the course administrator decided to enlist a mentor pool, mentors may guide mentee sub-groups. If the course administrator has decided not to offer supplementary mentors, then the first group is to take the entire course without mentors, though the course administrator does have the option to change this circumstance for the first group in future units.

In coursing the first unit, some students in the first group may drop out as per the criteria specified by the course administrator. Some may not fulfill the passing requirements and therefore not pass the first unit, and of course, some may pass. Those who dropped out are no longer part of the course. Those who did not pass the unit are to repeat the unit alongside the second group once they begin the unit. Such students are now considered to be part of the second group. The students that do pass the first unit are to progress to the second unit, which, as alluded to earlier, is a mentor unit.

Once the allocated time to complete the first unit is over and both the first and second groups are ready to commence a new unit, the assignment of mentors and peers for every group process ensures that students from the second group, now coursing unit 0 and thus considered mentees, are assigned mentors from the first group, again keeping the numbers within the mentee sub-groups as closely as possible to the desired mentee-mentor ratio, which is facilitated by the relative group sizes between the first and second groups. The second group is to follow the first unit in a similar fashion to the first group, except for the fact that they will be guided by mentors from the first unit. The second unit, now being taken by the first group, consists entirely of each mentor dedicating themselves fully to the success of their respective mentee sub-groups taking the first unit. The course coordinator will have at this point introduced specific expectations for mentors, e.g., meeting with the mentees a minimum number of times per unit, and importantly, that a key passing criteria of mentors is fora specified percentage of their mentees passes the first unit. Some mentors, just like could happen with mentees, may not meet the criteria for remaining in the course by, e.g., not meeting with their mentee sub-groups the required number of times. Other mentors may have had an insufficient number of students passing the first unit.

For those mentors who progress to the third unit, they will be taking this unit as mentees once more. The process followed by them is similar to what occurred in the first unit, and thus the first group continues through the course until they reach one final, preferably mentor unit. The reason for the choice of word “preferable” is because the course administrator may decide for the final unit to be a mentee unit, but this would have the undesirable effects of all groups not having the opportunity to be mentored on their final mentee unit as well as not having the opportunity to reinforce the knowledge they gained on their final mentee unit.

As for the second group, they continuously follow the tracks of the first group, being guided by them as their mentees in mentee units. They in turn guide the third group as mentors, and so on.

The final group's behavior—if there is a final group and no “infinite course offering”—is somewhat different. Because they do not have a group after them, they will not have the opportunity to mentor anybody except those students in the final group that do not pass units and therefore build up a (preferably small) population of students who now make up the final group, but because it is likely that this built up final group will remain smaller than the original final group, not all students from the original final group may have opportunities of mentorship. The students in the final group in mentor units that do not get to mentor anybody are to study extra material of the previous unit, with extra assessments. Because the group above them at these points will be in mentee units, students in the final group are to form mentee sub-groups in order to continue to collaborate with each other—but without the guidance of a mentor.

After all groups have completed the final unit or dropped off, and the course administrator decides not to continue admitting new students, the course is considered closed. However, the course administrator has the option to alter the nature of the course in various ways as the course itself is active. This further provides opportunities for educators and learners to create/evolve/attend courses that are continuously and indefinitely active.

This, in the above example, the course administrator has by this point allowed the student in the first group to begin the first unit: theory of differentiation. Because the course administrator is versed in calculus, they decide to mentor the student in the first group themselves, who is at this point a mentee. The course administrator seems to have done an excellent job in their admissions, as the first mentee attends every required meeting, hands in all required assessments on time, and has perfect scores on all of them. Now the student progresses to the second unit and is to mentor the two students in the second group, who are also perfect mentees, pass the first unit with excellence and therefore, the mentor from the first group also passes the second unit. While the student in the first group progresses to the mentee unit where they will learn about theory of integration, the two students, now mentors, from the second group are now in the second unit and are to mentor the four students in the third group who shall take the first unit—two for each mentor. They are also perfect mentees. This pattern continues until all seven students have graduated from the calculus course. The entire example dynamic is illustrated in FIG. 16.

What is claimed is:

1. A system for facilitating online education, the system comprising a processor and a memory, the system configured to implement a method comprising the steps of:
creating, by an authentication service, upon execution by the processor, a user record in a user database;
broadcasting, by a messaging service, upon execution by the processor, announcements, notifications, and communications among users of the system;
verifying, by an educational credential validation service, upon execution by the processor, credentials of prospective students for admission to a courses;
facilitating, by a meet service, upon execution by the processor, communications between the users, wherein the communications comprise video conferencing, wherein a request for communication is received through a student service;
providing an interface, by a search service, upon execution by the processor, for searching courses by the users;
generating, by a dropout service, upon execution by the processor, dropout information based on dropout students from the courses; and
rearranging, by a group formation service, upon execution by the processor, mentor groups based on the dropout information for predefined mentee-mentor ratio.

2. The system according to claim 1, wherein a course material microservice search is configured to generate a copy of course material data, wherein the copy is adapted for searching the course material data, through the interface.

3. The system according to claim 1, wherein the method further comprises:
querying, by the dropout service, the course administration to check active courses;
receiving retention criteria for each course;
determine information about students enrolled in each courses, wherein the dropout information is generated based on the information about students and retention criteria.

4. The system according to claim 3, wherein the method further comprises:
receiving, dropout information, by a student service; and
updating, by the student service, records of the students.

5. The system according to claim 1, wherein the method further comprises:
receiving, by an admission service, course requirements, from a course administration service;
presenting, by the admission service, an application form on a user device, the application profile is for receiving prerequisite course completion;
upon receiving proof of prerequisite course completion, querying the educational credentials validation service using the proof of prerequisite course completion;
receiving, by the admission service, from an assessment service, an assessment of users; and
requesting, by the admission service, generation of a student record with corresponding course ID.

6. The system according to claim 1, wherein the method further comprises:
generating, by a course administration service, a data model for course material, the data model has fields comprising course ID, course name, course administrator ID, number of units, minimum number of students in a first group, mentee-mentor ratio, minimum mentee pass rate for mentors to pass, course status, dropout criteria type, mentor-mentee rearrangement strategy type.

7. A method for facilitating online education, the method implemented within a system comprising a processor and a memory, the method comprising:
creating, by an authentication service, upon execution by the processor, a user record in a user database;
broadcasting, by a messaging service, upon execution by the processor, announcements, notifications, and communications among users of the system;
verifying, by an educational credential validation service, upon execution by the processor, credentials of prospective students for admission to a courses;
facilitating, by a meet service, upon execution by the processor, communications between the users, wherein the communications comprise video conferencing, wherein a request for communication is received through a student service;
providing an interface, by a search service, upon execution by the processor, for searching courses by the users;
generating, by a dropout service, upon execution by the processor, dropout information based on dropout students from the courses; and
rearranging, by a group formation service, upon execution by the processor, mentor groups based on the dropout information for predefined mentee-mentor ratio.

8. The method according to claim 7, wherein a course material microservice search is configured to generate a copy of course material data, wherein the copy is adapted for searching the course material data, through the interface.

9. The method according to claim 7, wherein the method further comprises:
querying, by the dropout service, the course administration to check active courses;
receiving retention criteria for each course;
determine information about students enrolled in each courses, wherein the dropout information is generated based on the information about students and retention criteria.

10. The method according to claim 9, wherein the method further comprises:
receiving, dropout information, by a student service; and
updating, by the student service, records of the students.

11. The method according to claim 7, wherein the method further comprises:
receiving, by an admission service, course requirements, from a course administration service;
presenting, by the admission service, an application form on a user device, the application profile is for receiving prerequisite course completion;
upon receiving proof of prerequisite course completion, querying the educational credentials validation service using the proof of prerequisite course completion;
receiving, by the admission service, from an assessment service, an assessment of users; and
requesting, by the admission service, generation of a student record with corresponding course ID.

12. The method according to claim 7, wherein the method further comprises:
generating, by a course administration service, a data model for course material, the data model has fields comprising course ID, course name, course administrator ID, number of units, minimum number of students in a first group, mentee-mentor ratio, minimum mentee pass rate for mentors to pass, course status, dropout criteria type, mentor-mentee rearrangement strategy type.
